(19) United States
(12) Patent Application Publication
(10) Pub. No.: US 2004/0000379 A1
(43) Pub. Date: Jan. 1, 2004

(54) Evaporation container and evaporation source

(75) Inventors: Steven Van Slyke, Pittsford, NY (US); Toshio Negishi, Ashigarakami-gun (JP)

Correspondence Address: Finnegan, Henderson, Farabow, Garrett & Dunner, L.L.P., 1300 I Street, N.W., Washington, DC, 20005-3315, US

(73) Assignee: ULVAC, INC.

(21) Appl. No.: 10/180,459

(22) Filed: Jun. 27, 2002

(51) Int. Cl. B01D 1/00

(52) U.S. Cl. 159/22; 159/28.1

(57) ABSTRACT

An evaporation source of the present invention has; a storage receptacle for accommodating an evaporation material, a cover member arranged thereabove and provided with a through hole, and a protective plate arranged beneath the through hole, and positioned with a rim portion outside of the periphery of the through hole. The cover member and the protective plate can be heated together. Even if the evaporation material melts and flies out in droplet form or solid particle form, the droplets or solid particles which fly out adhere to at least one of the cover member and the protective plate, and are then heated and vaporized. Therefore, the evaporation material does not fly out to outside the evaporation source in droplet form or solid particle form. Consequently, there is no deterioration in film quality, and the interior of the apparatus is not contaminated with the droplets or solid particles.

### BACKGROUND OF THE INVENTION

1. Field of the Invention

The present invention relates to an evaporation container and an evaporation source. In particular, the present invention relates to technology used in the manufacture of organic LED elements, for vacuum depositing thin films of organic material.

2. Description of the Related Art

Recently, organic LED elements are attracting attention as elements for full-color flat panel displays. Organic LED elements are spontaneous light emission elements which emit light by electrically exciting a fluorescent organic compound, and are capable of multicolored emission with a high intensity, high viewing angle, planar emission, and a thin form. Moreover, as overall solid-state devices that emit light by direct current application of a low voltage of several volts, these also have the feature that even at low temperatures, changes in characteristics are minimal.

Such organic LED elements have an organic multi-layered film, and in the manufacture of organic LED elements, technology for depositing organic thin films is essential. Usually, to deposit the organic thin film, the vacuum evaporation method is used.

FIG. 8 is an schematic diagram of a vacuum evaporation apparatus of the prior art for depositing an organic thin film at the time of manufacturing a conventional LED device.

As shown in FIG. 8, in this vacuum evaporation apparatus 101, a pair of evaporation sources 103a and 103b are disposed at the bottom of a vacuum chamber 102, and a substrate holder 106 is arranged above and inward of these evaporation sources 103. The substrate holder 106 is constructed so as to hold a substrate being the object of deposition.

These evaporation sources 103a and 103b respectively comprise; closed bottom receptacles 130a and 130b, evaporation materials 140a and 140b consisting of organic materials stored inside the receptacles 130a and 130b, and heaters 131a and 131b arranged in close contact with the periphery of the receptacles 130a and 130b. The heaters 131a and 131b are formed from a resistance heating element and are connected to a power source 170 arranged on the outside of the vacuum chamber 102. When the power source 170 is activated and electricity flows to the heaters 131a and 131b, the heaters 131a and 131b generate heat and the receptacles 130a and 130b heat up, so that the evaporation materials 140a and 140b inside the receptacles 130a and 130b heat up and melt or sublimates, and are vaporized.

In order to deposit an organic thin film on the surface of a substrate using such a vacuum evaporation apparatus 101, the interior of the vacuum chamber 102 is evacuated beforehand to a predetermined degree of vacuum with an evacuation system, and in a condition with the vacuum of the interior of the vacuum chamber 102 maintained, the substrate is introduced to inside the vacuum chamber 102, and the substrate is held on the substrate holder 106 with the surface facing downwards. The substrate is denoted by reference symbol 105 in FIG. 8. Then, a mask 104 formed with a desired pattern is arranged below the surface of substrate 105.

After that, the power source 170 is activated, and each of the evaporation materials 140a and 140b are vaporized from the evaporation sources 103a and 103b. As a result, the vapor from the evaporation materials 140a and 14b rises, and reaches the surface of substrate 105 via the mask 104, and an organic thin film of the same pattern as that formed on the mask 104 is deposited on the surface of the substrate 105.

However, in recent years, with the pitch of the mask becoming finer, in conventional technology, it is difficult to obtain a uniform film thickness distribution. Therefore, as well as unevenness arising in the light emission of the pixels, this leads to a deterioration of the elements because of an excessive current flow in the regions of thin film thickness. Consequently the life span of the organic LED devices is limited. As a result, there is a demand to deposit an organic thin film with a uniform film thickness.

Moreover, a part of the heated and melted or sublimated organic evaporation material can fly out in droplet form or solid particle form. If that droplet or solid particle of evaporation material which flies out, is discharged to outside of the evaporation source, and adheres to the inner wall of the vacuum evaporation apparatus, the interior of the evaporator becomes contaminated. Furthermore, if that droplet or solid particle reaches the substrate surface, the film quality of the deposited thin film is lowered.

### SUMMARY OF THE INVENTION

The present invention has been achieved to solve the deficiencies of the above-mentioned conventional technology, with the object of providing technology for forming an organic thin film at a uniform film thickness distribution and with good film quality.

In order to address the above problems, an evaporation container according to a first aspect of the present invention comprises: a storage receptacle; a cover member which is positioned near an opening of the storage receptacle and covers the opening of the storage receptacle; a through hole which is provided in the cover member and communicates with the opening of the storage receptacle; and a protective plate arranged apart from the cover member, between the through hole of the cover member and an internal bottom surface of the storage receptacle, wherein a peripheral portion of the protective plate is positioned outside of a periphery of the through hole.

The cover member and the protective plate may comprise resistance heating elements.

The evaporation container may further comprise an attachment member comprising a conductive material, and the protective plate may be attached to the cover member by the attachment member such that, when a voltage is applied to the cover member, an electric current flows to the protective plate via the attachment member.

The cover member may be formed in a rectangular shape, and electric current input terminals may be respectively provided one on each end of the cover member.

A second aspect of the present invention is an evaporation source. This evaporation source comprises: a storage receptacle; an evaporation material arranged inside the storage receptacle; a cover member which is positioned near an opening of the storage receptacle and covers the opening of the storage receptacle; a through hole which is provided in the cover member and communicates with the opening of the storage receptacle, and a protective plate arranged apart from the cover member, between the through hole of the cover member and an internal bottom surface of the storage receptacle, wherein a peripheral portion of the protective plate is positioned outside of a periphery of the through hole, and the cover member and the protective plate are constructed so as to generate heat and heat the evaporation material.

In the evaporation source, when the evaporation material is heated, and melted or sublimated, and the melted or sublimated evaporation material becomes droplets or solid particles and flies out, a locus of the droplets or solid particles may intersect with at least one of the cover member and the protective plate.

The cover member and the protective plate may comprise resistance heating elements.

The evaporation source may further comprise an attachment member comprising a conductive material, and the protective plate may be attached to the cover member by the attachment member so that, when a voltage is applied to the cover member, a current flows to the protective plate via the attachment member.

The cover member may be formed in a rectangular shape, and electric current input terminals may be respectively provided one on each end of the cover member.

As explained above, the evaporation container of the present invention has: a storage receptacle, a cover member, a through hole provided in the cover member, and a protective plate. The protective plate is arranged between the through hole and the internal bottom surface of the storage receptacle, and the peripheral portion of the protective plate is positioned outside of a periphery of the through hole. The protective plate is attached to the cover member by the attachment member that comprises a conductive material, the construction being such that when a voltage is applied to the cover member, an electric current can flow to the cover member and also, the electric current can flow to the protective plate via the attachment member.

In the case where the cover member and the protective plate are formed with resistance heating elements, by applying a voltage to the cover member so that a current flows from the cover member to the protective plate via the attachment member, it is possible to heat both the cover member and the protective plate.

In the evaporation source of the present invention, the evaporation material is stored inside the storage receptacle, the cover member and the protective plate are heated, and the evaporation material is melted or sublimated. Then, in the case where droplets or solid particles of the melted or sublimated evaporation material fly out, the locus of the droplets or solid particles intersect with at least one of the cover member or the protective plate.

By comprising such a construction, the droplet form or solid particle form evaporation material which flies out reaches the surface of at least one of the cover member or the protective plate. If the cover member and the protective plate are heated together, then even if the flown out droplet form or solid particle form evaporation material reaches the surface, that evaporation material is heated by the cover member and the protective plate, and vaporizes, and is released to outside of the evaporation source as vapor. Consequently, the droplet form or solid particle form evaporation material does not fly out to outside of the evaporation source. As a result, the problems arising in the conventional technology such as contamination of the vacuum evaporation apparatus interior and deterioration of the film quality of the thin film no longer arise.

A vacuum evaporation method of the present invention comprises:

providing an evaporation source which includes a storage receptacle in which an evaporation material is arranged; a cover member which is positioned near an opening of the storage receptacle and covers the opening of the storage receptacle; a through hole which is provided in the cover member and communicates with the opening of the storage receptacle; and a protective plate arranged apart from the cover member, between the through hole of the cover member and an internal bottom surface of the storage receptacle, wherein a peripheral portion of the protective plate is positioned outside of a periphery of the through hole;

providing a substrate so as to face the through hole of the cover member;

heating the evaporation material in the storage receptacle so that vapor, droplets, and solid particles fly out of the evaporation material;

blocking the droplets or solid particles by the protective plate to prevent the droplets or solid particles from flying out of the through hole;

bringing the vapor flowing out of the through hole into contact with the substrate to form a film of the evaporation material on the substrate.

### BRIEF DESCRIPTION OF THE DRAWINGS

FIG. 1 is a front elevation cross-section of a vacuum evaporation apparatus according to an embodiment of the present invention.

FIG. 2A is a side elevation cross-section of the vacuum evaporation apparatus according to the embodiment of the present invention.

FIG. 2B is a plan view of a partition portion used in the vacuum evaporation apparatus according to the embodiment of the present invention.

FIG. 3 is a plan view explaining an evaporation source according to the embodiment of the present invention.

FIGS. 4A and 4B are first cross-sections explaining the evaporation source according to the embodiment of the present invention.

FIGS. 5A and 5B are second cross-sections explaining the evaporation source according to the embodiment of the present invention.

FIG. 6 is an explanatory diagram showing a positional relationship between the evaporation source, an aperture and a mask according to the embodiment of the present invention.

FIG. 7A is a plan view explaining an evaporation source according to an other embodiment of the present invention.

FIG. 7B is a cross-section explaining the evaporation source according to the other embodiment of the present invention.

FIG. 8 is a cross-section explaining a conventional vacuum evaporation apparatus of the prior art.

### DESCRIPTION OF THE PREFERRED EMBODIMENTS

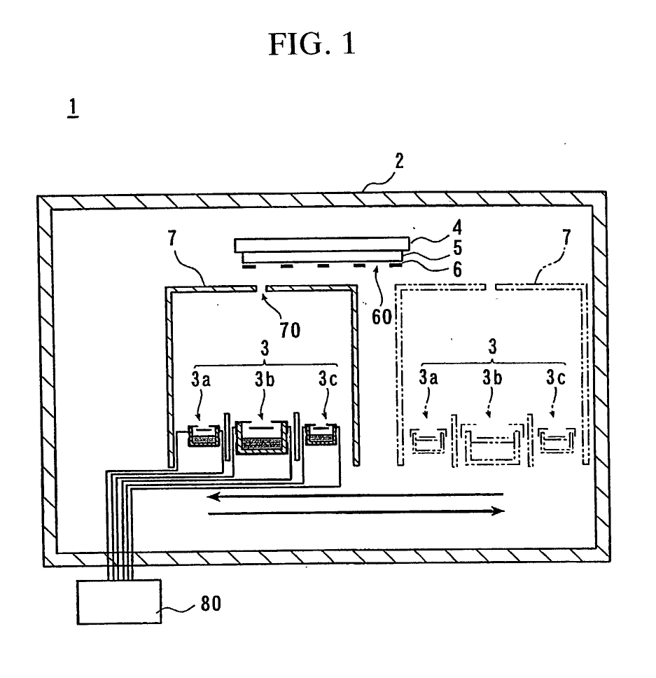

Hereunder is a description of embodiments of the present invention with reference to the drawings. Reference symbol 1 in FIG. 1 denotes a film deposition apparatus in which the evaporation source of the present invention is used.

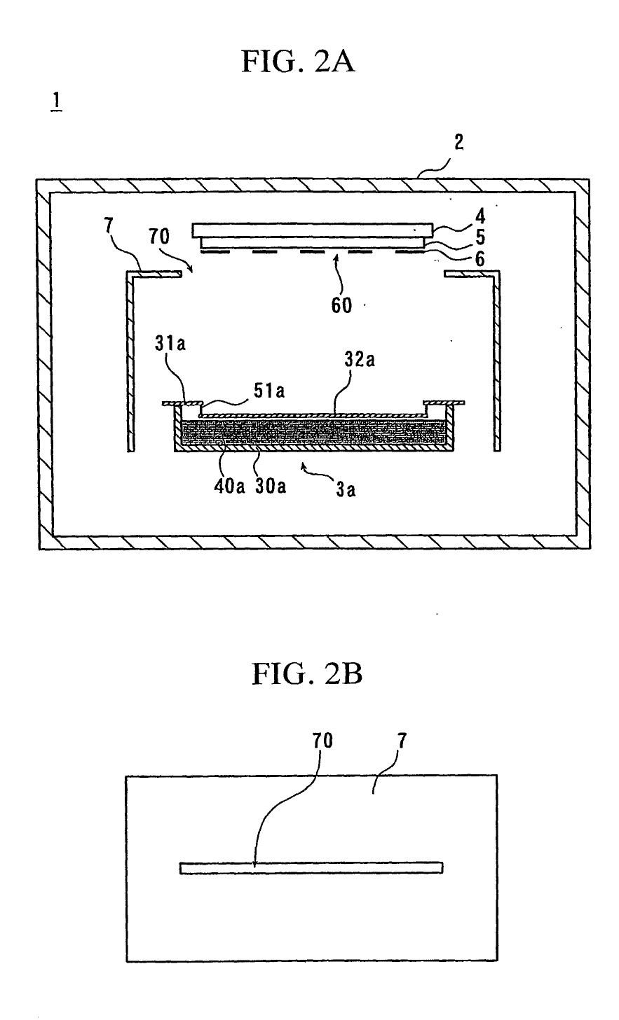

FIG. 1 is a front elevation cross-section of a preferred embodiment of the thin film deposition apparatus according to the present invention. FIG. 2A is a side elevation cross-section of the same thin film deposition apparatus, and FIG. 2B is a plan view of a partition portion of the same embodiment.

As shown in FIG. 1, the film deposition apparatus 1 of the present embodiment has a vacuum chamber 2 connected to a vacuum evacuation system (not shown in the figure), and an evaporation source 3 is arranged at the bottom of the interior of the vacuum chamber 2.

The evaporation source 3 is constituted by a plurality (in this case three) of evaporation sources 3a, 3b and 3c.

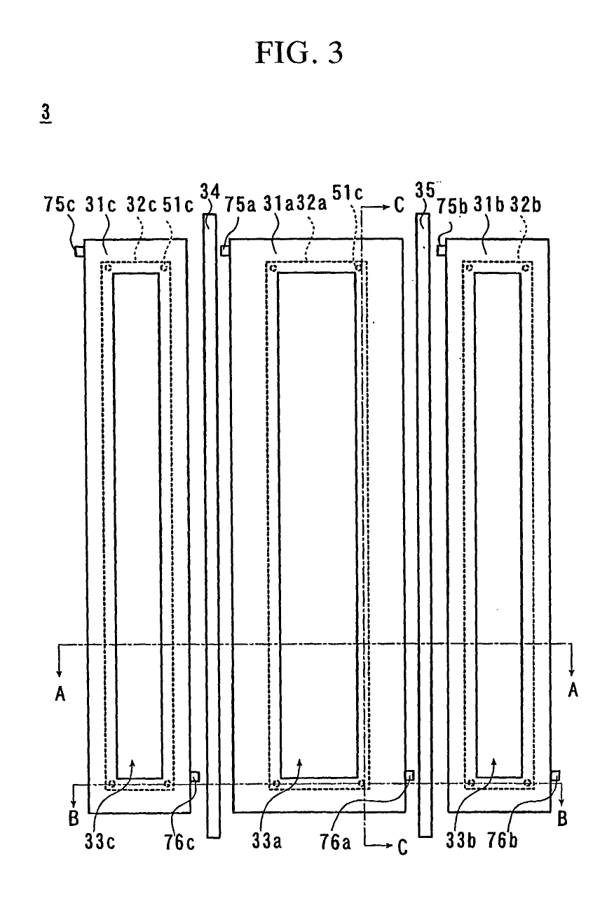

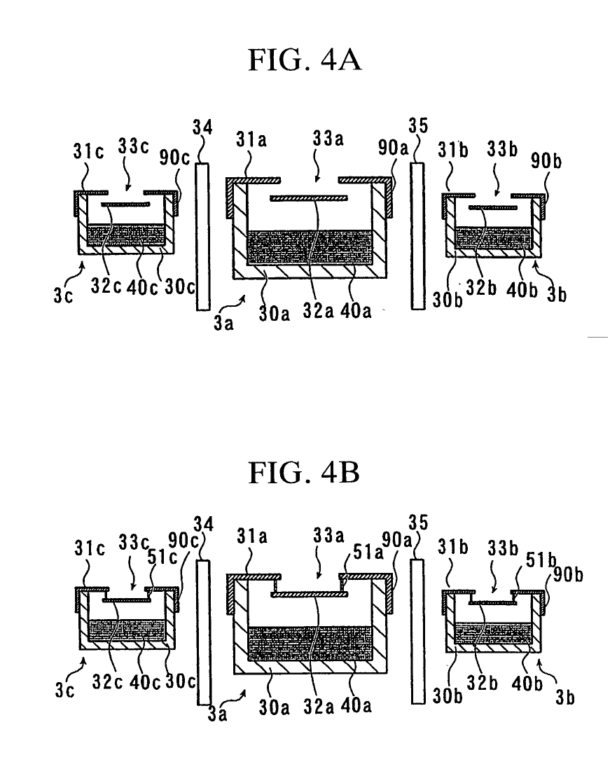

FIG. 3 shows a plan view of the evaporation source 3. FIGS. 4A and 4B respectively, show cross-sections on line A-A, and line B-B in FIG. 3.

Each evaporation source 3a, 3b, and 3c is an elongated rectangular shape in plan, and has bottomed storage receptacles 30a, 30b and 30c comprising quartz. These storage receptacles 30a, 30b, and 30c are arranged with each opening facing upwards, and so as to be mutually parallel to the longitudinal direction. Of these, the storage receptacles 30b, and 30c are arranged on either side of the storage receptacle 30a.

Cover members 31a, 31b and 31c are respectively arranged above the respective storage receptacles 30a, 30b and 30c.

The cover members 31a, 31b and 31c comprise a plate of elongated rectangular shape in plan, and opposite sides of the lengthwise sides (hereunder referred to as the long side) are both folded perpendicularly. The folded portions are denoted respectively by reference symbols 90a, 90b and 90c in FIGS. 4A and 4B. In the cover members 31a, 31b and 31c, the long sides are longer than the long sides of the respective storage receptacles 30a, 30b and 30c. Moreover, the space between the folded portions 90a, 90b and 90c of the respective cover members 31a, 31b and 31c is slightly larger than the width of the storage receptacles 30a, 30b and 30c. In the condition with the cover members 31a, 31b and 31c mounted on the respective storage receptacles 30a, 30b and 30c, with the folded portions 90a, 90b and 90c facing perpendicularly downwards, these can cover the openings of the storage receptacles 30a, 30b and 30c in the mounted condition. In the present embodiment, the lengths of the long sides of the cover members 31a, 31b and 31c are all 600 mm. Moreover, the width of the cover member 3 la on the centrally arranged storage receptacle 30a is 26 mm, and the width of the cover members 31b and 31c on the storage receptacles 30b and 30c arranged on either side is 10 mm.

Through holes 33a, 33b and 33c of an elongated rectangular shape in plan, are respectively provided in an approximately central region of each cover member 31a, 31b and 31c. In the present embodiment, the longitudinal length of the through holes 33a, 33b and 33c are all 500 mm. Moreover, the width of the centrally arranged through hole 33a is 10.6 mm, and the width of the through holes 33b and 33c arranged on either side is 4.2 mm.

Below each of the through holes 33a, 33b and 33c, protective plates 32, 32b and 32c are respectively arranged horizontally between each of the through holes 33a, 33b and 33c and the internal bottom surface of the respective storage receptacles 30a, 30b and 30c, and away from the respective cover members 31a, 31b and 31c.

The protective plates 32a, 32b and 32c are all formed in an elongated rectangular plate shape, and are all formed larger than the respective through holes 33a, 33b, and 33c. The protective plates 32a, 32b and 32c are arranged so that their respective rim portions are positioned outside of the periphery of the respective through holes 33a, 33b and 33c.

In the present embodiment, the width of the protective plate 32a inside the storage receptacle 30a arranged in the center is 16 mm, and the width of the protective plates 32b and 32c inside the storage receptacles 30b and 30c arranged on either side is 13 mm.

At portions of the four corners of the protective plates 32a, 32b and 32c, being the portions facing the bottom faces of the respective cover members 31a, 31b and 31c, as shown in FIG. 4B, there is secured lower ends of respective rod shaped attachment members 51a, 51b, and 51c. The upper end of these attachment member 51a, 51b and 51c are secured to the bottom face of the cover members 31a, 31b and 31c respectively. As a result, the protective plates 32a, 32b and 32c are suspended from the cover members 31a, 31b and 31c by the respective attachment members 51a, 51b and 51c.

The protective plates 32a, 32b and 32c are arranged apart from the respective cover members 31a, 31b and 31c, and as shown in FIG. 4A, at the places where the attachment members 51a, 51b and 51c are not provided, a space is provided between the protective plates 32a, 32b and 32c, and the respective cover members 31a, 31b and 31c.

At the first end of the elongate cover members 31a, 31b and 31c, electric current input terminals 75a, 75b and 75c are respectively attached one for each. Moreover at the second end of the cover members 31a, 31b and 31c, electric current input terminals 76a, 76b and 76c are respectively attached one for each.

These electric current input terminals 75a, 75b, 75c, 76a, 76b and 76c are all connected to an electric source 80 arranged on the outside of the vacuum chamber 2.

The cover members 31a, 31b and 31c and the respective protective plates 32a, 32b and 32c are all formed from a resistance heating element such as tantalum (Ta). Moreover, the attachment members 51a, 51b and 51c are formed from a conducting material such as tantalum. When the electric source 80 is activated, an electric current flows from the electric current input terminals 75a, 75b and 75c respectively provided at one end of the cover members 31a, 31b and 31c, to the protective plates 32a, 32b and 32c via the respective cover members 31a, 31b and 31c and the attachment members 51a, 51b and 51c. After that, the current flows to the electric current input terminals 76a, 76b and 76c respectively provided at the other end of the cover members 31a, 31b and 31c via the attachment members 51a, 51b and 51c and the respective cover members 31a, 31b and 31c.

In this way, the electric current flows in the longitudinal direction of the cover members 31a, 31b and 31c and the respective protective plates 32a, 32b and 32c, and flows over substantially all regions of these.

As mentioned above, the cover members 31a, 31b and 31c and the protective plates 32a, 32b and 32c are all formed from a resistance heating element, and when the electric current flows, the cover members 31a, 31b and 31c, and the protective plates 32a, 32b and 32c all produce heat. The electric current, as mentioned above, flows over substantially all regions of the cover members 31a, 31b and 31c and the protective plates 32a, 32b and 32c. Therefore, substantially all regions of the cover members 31a, 31b and 31c and the protective plates 32a, 32b and 32c produce heat uniformly.

Partition plates 34 and 45 are respectively arranged perpendicularly between the above-mentioned evaporation sources 3a, 3b and 3c.

Moreover, in the present embodiment, a partition member 7 is arranged above the evaporation source 3 inside the vacuum chamber 2. The partition member 7 comprises a material such as aluminum (Al), formed in a bottomed container shape with a rectangular shape in plan, and is arranged so as to cover the evaporation source 3 from above, in a condition with the opening thereof facing perpendicularly downwards.

As shown in FIG. 1 and FIGS. 2A and 2B, an elongated slit shaped aperture 70 is provided in a central portion of an upper portion of the partition member 7, directly above the evaporation source 3.

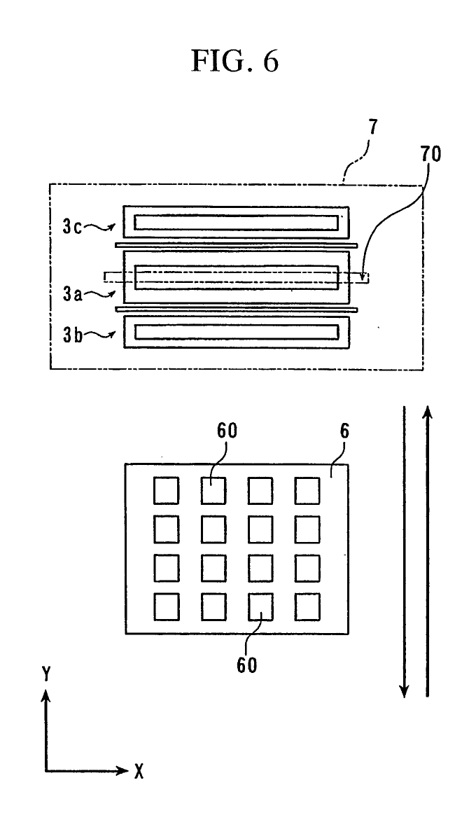

As shown in FIG. 2A and FIG. 6, this aperture 70 is provided approximately parallel to the through holes 33a, 33b, and 33c of the evaporation sources 3a, 3b and 3c.

As shown in FIG. 1, in the present embodiment, the construction is such that the evaporation source 3 and the partition member 7 are moved together synchronously in the same direction, using for example a ball screw (not shown in the figures). In this case, the direction in which the evaporation source 3 and the partition member 7 move, is the widthwise direction of the evaporation sources 3a, 3b, and 3c and the aperture 70.

A substrate holder 4 is provided at the interior ceiling of the vacuum chamber 2. This substrate holder 4 is constructed so as to be able to hold the substrate which is to be deposited with the vapor film, in a condition with the deposition surface facing perpendicularly downward. In FIG. 1, a condition is shown with the substrate held in the substrate holder 4. The held substrate is denoted by reference symbol 5. A mask 6 is arranged close beneath the held substrate 5.

In order to deposit an organic thin film on the substrate surface, being the object of deposition, with the film deposition apparatus of the above-mentioned construction, firstly, of the storage receptacles 30a, 30b and 30c of the evaporation source 3, the evaporation material that becomes the host material for the organic thin film is inserted inside the centrally arranged storage receptacle 30a, and the evaporation materials that become the respective dopant materials for the organic thin film are inserted inside the storage receptacles 30b and 30c respectively arranged on either side of the storage receptacle 30a.

For example, the evaporation material that becomes the host material is Alq₃ (tris-(8-hydroxyquinoline)aluminum(III)), and the evaporation material that becomes the dopant material is DCJTB (Propanedinitrile, [2-(1,1-dimethylethyl)-6-[2-(2,3,6,7-tetrahydro-1,1,7,7-tetramethyl-1H,5H-benzo[ij]quinolizin-9-yl)ethenyl]) and Rubrene. Reference symbols 40a, 40b and 40c in the figure denote the evaporation materials respectively stored in the storage receptacles 30a, 30b and 30c.

The substrate 5 is held in the substrate holder 4 with the deposition surface facing perpendicularly downwards, and the mask 6 is arranged close beneath the held substrate 5. Moreover, the evaporation source 3 and the partition member 7 are moved, so that the central axis of the aperture 70 of the partition member 7 is positioned at a position outside of the mask 6. The position of the evaporation source 3 and the partition member 7 in that condition is shown by the two dot chain line in FIG. 1.

In this condition, the vacuum evacuation system is activated, and the interior is evacuated. Once the pressure of the interior of the vacuum chamber 2 falls below a pressure appropriate for vacuum evaporation, the power source 80 is activated. As a result, the cover members 31a, 31b and 31c and the protective plates 32a, 32b and 32c of the evaporation source 3 generate heat.

The evaporation materials 40a, 40b and 40c stored in the respective storage receptacles 30a, 30b, and 30c, as shown in FIGS. 4A and 4B, are arranged below the respective protective plates 32a, 32b and 32c, and when the cover members 31a, 31b and 31c and the protective plates 32a, 32b and 32c generate heat, the evaporation materials 40a, 40b and 40c are heated and melted or sublimated, and vaporize from the liquid or solidified surface thereof.

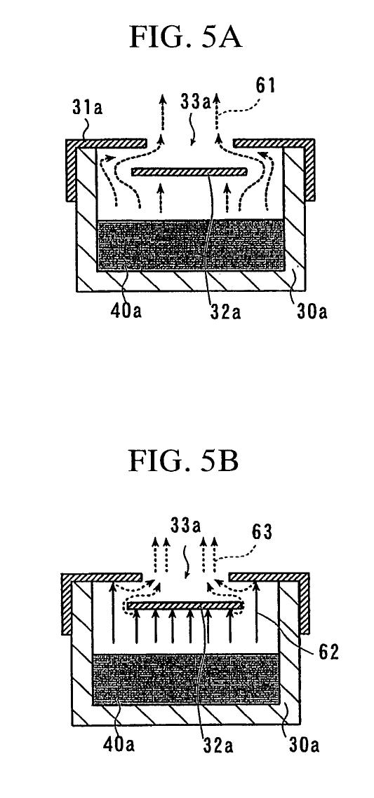

FIG. 5A is a cross-section diagram showing a condition for the centrally arranged evaporation source 3, where the evaporation material 40a stored thereinside is vaporized. Reference symbol 61 in the figure denotes the flow of vapor of the evaporation material 40a. This vapor 61 flows from the surface of the evaporation material 40a and passes through the space between the protective plate 32a and the cover member 31a, and is then discharged from the through hole of the cover member 31a to outside of the evaporation source 3a. In FIG. 5A, the situation for the evaporation source 3a arranged in the center is described, but the description is similar for with the evaporation sources 3b and 3c on either side. The vapor of the respective evaporation materials 40a, 40b and 40c, that is, Alq₃ (tris-(8-hydroxyquinoline)aluminum(III)), DCJTB, and Rubrene are discharged from the through holes 33a, 33b and 33c of the respective evaporation sources 3a, 3b and 3c.

These vapors pass through the aperture 70 of the partition member 7, and are discharged to above the aperture 70, and pass through the mask 6 to reach the surface of the substrate 5, so that organic thin films comprising the evaporation materials are formed on the surface of the substrate 5 which they reach.

While the vapor of the evaporation materials is being discharged from the aperture 70, the evaporation source 3 and the partition member 7 move at a constant velocity in a widthwise direction of the aperture 70. At this time, the range of movement of the evaporation source 3 and the partition member 7 is a range extending from a home position shown by the two dot chain line in FIG. 1, to where the aperture 70 has traversed the entire surface of the substrate 5. In FIG. 1, the arrows show the range of movement of the central axis of the aperture 70 of the partition member 7. Here, while the vapor of the evaporation material is being discharged from the aperture 70, the evaporation source 3 and the partition member 7 move once back and forth over the range shown by the arrows.

As shown in FIG. 6, a plurality of device patterns 60 for deposition of a pre-determined thin film on the substrate 5, are formed in the mask 6. As a result, an organic thin film of the same pattern as the device patterns 60 is deposited on the surface of the substrate 5.

As mentioned above, according to the present embodiment, the aperture 70 for limiting the evaporation region of the substrate 5, is provided in the partition member 7 that divides the space between the substrate 5 and the evaporation source 3, and vapor of the evaporation material 40 which is uniformly discharged from this aperture 70, is deposited on the surface of the substrate 5. Therefore, it is possible to achieve uniformity of the film thickness distribution.

As a result, according to the present embodiment, and well as being able to prevent light emission uneveness of the pixels of organic LED devices, it is possible to achieve an increase in life.

In addition, because the portion excluding the aperture 70 in the space between the evaporation source 3 of the vacuum chamber 2 and the mask 6 is divided by the partition member 7, heat from the evaporation source 3 does not transmit easily to the mask 6. Consequently, it is possible to prevent displacement of the deposition region, attributable to distortion of the mask 6.

Moreover, in the present embodiment, by moving the elongate shape aperture 70 in the widthwise direction, then even in the case where a plurality of pattern depositions are performed using a large sized substrate 5, the film thickness distribution of each evaporation region of the substrate 5 will be reliably uniform.

Incidentally, as mentioned above, the melted or sublimated evaporation material is such that a large proportion is discharged to the outside as vapor, but a part thereof flies out as droplets or solid particles from the liquid or solidified surface of the evaporation material 40a. Heretofore, these droplets or solid particles flew out to outside of the evaporation source, and if the droplets or solid particles that had flown out adhered to the substrate surface, this caused a problem with deterioration of the film quality of the thin film deposited on the substrate surface, and if these adhered to the interior wall surface of the film deposition apparatus 1, this caused a problem with contamination of the inside of the apparatus.

FIG. 5B shows the situation for the centrally arranged evaporation source 3a, where the evaporation material 40a stored thereinside, has melted or sublimated and the droplets or solid particles of the evaporation material have flown out. Reference symbol 62 in the figure denotes the loci of droplets or solid particles of the evaporation material that fly out from the liquid surface.

The loci 62 of the droplets or solid particles of the evaporation material, as shown in FIG. 5B are straight lines. The protective plate 32a is arranged between the through hole 33a and the bottom interior surface of the storage receptacle 30a. Because the edge rim of the protective plate 32a is positioned outside of the periphery of the through hole 33a, the loci 62 of the droplets or solid particles that fly out in a straight line, will definitely intersect at least one of the protective plate 32a and the cover member 31a. Therefore, the droplets or solid particles reach the surface of the protective plate 32a or the cover member 31a.

As mentioned above, because the protective plate 32a and the cover member 31a are both heated, the droplets or solid particles of evaporation material that reached these surfaces are heated and become vapor according to the surface reached, of the protective plate 32a or the cover member 31a. In this way, regarding the vapor that is vaporized on the surface of protective plate 32a or the cover member 31a, the flow thereof as denoted by reference symbol 63 in the figure, passes though the space between the protective plate 32a and the cover member 31a, and is discharged from the through hole 33a of the cover member 31a to outside of the evaporation source 3a. Here the description has been for the centrally arranged evaporation source 3a, but the same applies for the evaporation sources 3b and 3c arranged on either side.

As explained above, in the evaporation source 3 of the present embodiment, even if the temporarily melted or sublimated evaporation material flies out in droplet form or solid particle form, this reaches the surface of the protective plates 32a, 32b and 32c or the cover members 31a, 31b and 31c, and is heated and vaporized, and discharged to the outside as vapor. Therefore, there is no likelihood of the evaporation material flying out in droplet form or solid particle form to outside the evaporation source. Consequently, the droplet form or solid particle form evaporation material will not disperse to outside the evaporation source, and hence the interior of the apparatus will not be contaminated, and the film quality will not be deteriorated.

In addition, as mentioned above, because the cover members 31a, 31b and 31c and the protective plates 32a, 32b and 32c are all heated uniformly, the evaporation materials 40a, 40b and 40c will be heated substantially uniformly.

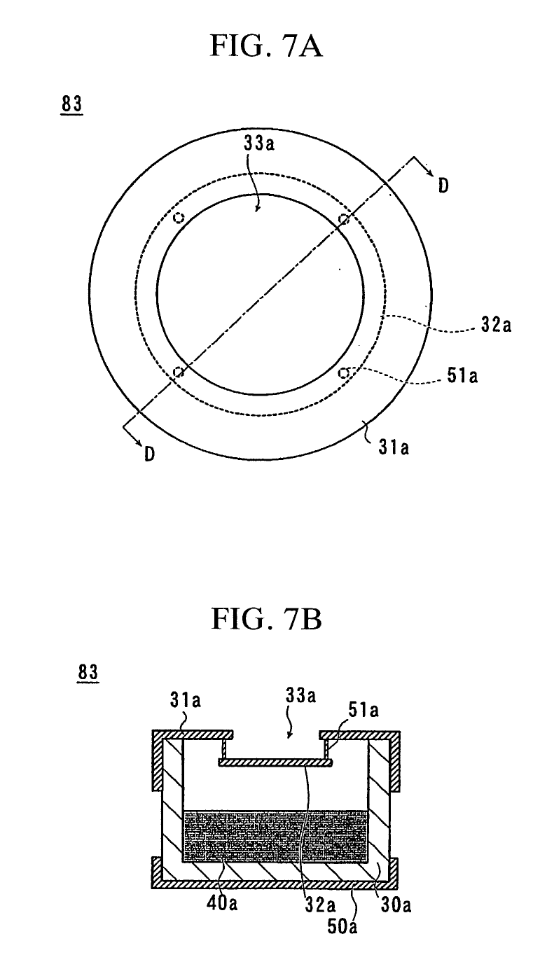

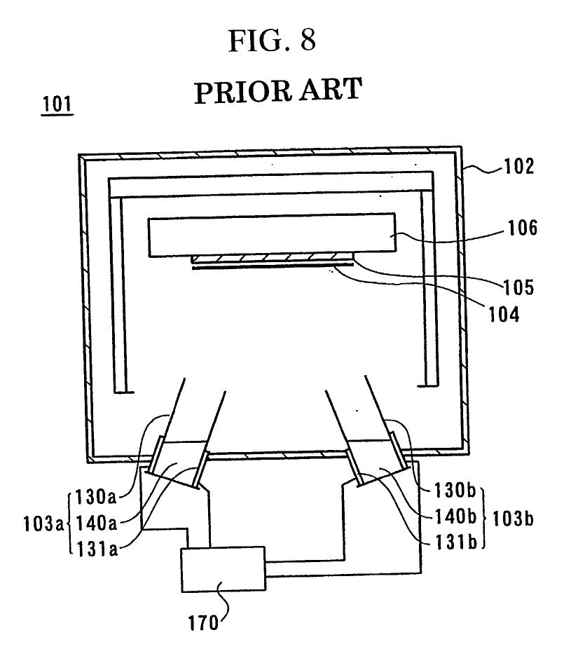

In the present embodiment mentioned above, each of the evaporation sources 3a, 3b, and 3c are formed in an elongated rectangle shape, but the shape of the evaporation sources of the present invention is not limited to this. One such example is denoted by reference symbol 83 in FIGS. 7A and 7B.

This evaporation source 83, as shown in FIGS. 7A and 7B is circular in planar shape, and has a storage receptacle 30a formed in a closed bottom cylindrical shape, a circular cover member 31a arranged thereabove, with a circular shaped through hole 33a provided in the centre of the cover member 31a, and a circular shaped protective plate 32a arranged below the through hole 33a. The protective plate 32a is suspended on four attachment members 51a.

In addition, a backup heater 50a consisting of for example tantalum (Ta) as with the cover member 31a or the protective plate 32a, is arranged below the storage receptacle 30a, so as to be capable of conducting electricity. When at the same time as conducting electricity to the cover member 31a and the protective plate 32a and generating heat, electricity is conducted to the backup heater 50a, the backup heater 50a generates heat and the evaporation material 40a arranged inside of the storage receptacle 30a is heated and melted or sublimated, and vaporizes. In this case, it is possible to melt the evaporation material and generate heat in a shorter time than in the case where only the cover member 31a and the protective plate 32a conduct electricity and generate heat. Of course, this backup heater 50a is not limited to being provided on the circular shaped evaporation source 83 shown in FIGS. 7A and 7B, but can also be provided on the above-mentioned elongate evaporation sources 3a, 3b and 3c.

In addition, in the above-mentioned embodiment, the conductive material attachment members 51a, 51b and 51c are arranged on the four corners of the respective protective plates 32a, 32b and 32c. However, the present invention it is not limited to this, provided the construction is such that if a voltage is applied to the cover member, an electric current flows to the protective plate as well. For example, the construction may be such that a total of two attachment members are arranged one on each side of the protective plate.

Moreover, the protective plate and the cover member are made from a resistance heating element, the construction being such that by conducting electricity to the protective plate and the cover member, these generate heat. However, the present invention is not limited to this, provided the construction is such that the protective plate and the cover member generate heat.

As an example, an apparatus constructed with an infrared ray irradiation device arranged inside the vacuum chamber, and a protective plate and a cover member made from materials with a low infrared ray transmissivity, is envisaged. In this case, if the protective plate and the cover member are irradiated with infrared rays, the protective plate and the cover member will be heated and warm up. Hence the protective plate and the cover member can be heated without using a resistance heating element.

Furthermore, in the above-mentioned embodiment, the aperture was moved by moving the evaporation source and the partition portion. However, the present invention is not limited to this, and it is also possible to move the substrate side.

Moreover, in the above embodiment, three evaporation sources are arranged in parallel. However two, or four or more evaporation sources may also be arranged in parallel, or one evaporation source may be arranged.

Furthermore, regarding the aperture 70, the X direction length is set so that the length is longer than the width of the substrate 5 which is the deposition object. Preferably from the perspective of a uniform film thickness, the width of the aperture 70 is smaller than the distance between the evaporation source 3 and the substrate 5, and more preferably is between ⅕ and ⅓ of the distance between the evaporation source 3 and the substrate 5.

Moreover, regarding the shape of the aperture, besides a rectangular shape, this may be an oval shape, a circular shape, a square shape and so forth. However, from the perspective of improving the film thickness distribution, preferably this is formed in a rectangular shape as in the above embodiment.

According to the present invention, it is possible to deposit a high film quality organic thin film at a uniform film thickness.

What is claimed is:

1. An evaporation container comprising:
a storage receptacle;
a cover member which is positioned near an opening of said storage receptacle and covers said opening of said storage receptacle;
a through hole which is provided in said cover member and communicates with said opening of said storage receptacle; and
a protective plate arranged apart from said cover member, between said through hole of said cover member and an internal bottom surface of said storage receptacle,
wherein a peripheral portion of said protective plate is positioned outside of a periphery of said through hole.

2. An evaporation container according to claim 1, wherein said cover member and said protective plate comprise resistance heating elements.

3. An evaporation container according to claim 1, further comprising an attachment member comprising a conductive material, wherein said protective plate is attached to said cover member by said attachment member so that, when a voltage is applied to said cover member, an electric current flows to said protective plate via said attachment member.

4. An evaporation container according to claim 1, wherein said cover member is formed in a rectangular shape, and electric current input terminals are respectively provided one on each end of said cover member.

5. An evaporation source comprising:
a storage receptacle;
an evaporation material arranged inside said storage receptacle;
a cover member which is positioned near an opening of said storage receptacle and covers said opening of said storage receptacle;
a through hole which is provided in said cover member and communicates with said opening of said storage receptacle, and
a protective plate arranged apart from said cover member, between said through hole of said cover member and an internal bottom surface of said storage receptacle,
wherein a peripheral portion of said protective plate is positioned outside of a periphery of said through hole, and
said cover member and said protective plate are constructed so as to generate heat and heat said evaporation material.

6. An evaporation source according to claim 5 constructed such that in a case where said evaporation material heated and melted or sublimated, and the melted or sublimated evaporation material becomes droplets or solid particles and flies out, a locus of said droplets or solid particles intersect with at least one of said cover member and said protective plate.

7. An evaporation source according to claim 5, wherein said cover member and said protective plate comprise resistance heating elements.

8. An evaporation source according to claim 5, further comprising an attachment member comprising a conductive material, wherein said protective plate is attached to said cover member by said attachment member so that, when a voltage is applied to said cover member, a current flows to said protective plate via said attachment member.

9. An evaporation source according to claim 5, wherein said cover member is formed in a rectangular shape, and electric current input terminals are respectively provided one on each end of said cover member.

10. A vacuum evaporation method comprising:
providing an evaporation source which includes:
a storage receptacle in which an evaporation material is arranged;
a cover member which is positioned near an opening of said storage receptacle and covers said opening of said storage receptacle;
a through hole which is provided in said cover member and communicates with said opening of said storage receptacle; and
a protective plate arranged apart from said cover member, between said through hole of said cover member and an internal bottom surface of said storage receptacle, wherein a peripheral portion of said protective plate is positioned outside of a periphery of said through hole;
providing a substrate so as to face said through hole of said cover member;
heating said evaporation material in said storage receptacle so that vapor, droplets, and solid particles fly out of said evaporation material;
blocking said droplets or solid particles by said protective plate to prevent said droplets or solid particles from flying out of said through hole;
bringing said vapor flowing out of said through hole into contact with said substrate to form a film of said evaporation material on said substrate.

11. A vacuum evaporation method according to claim 10, further comprising:
heating said protective plate and evaporating said evaporation material attached on said protective plate.
